(19) United States
(12) Patent Application Publication
(10) Pub. No.: US 2017/0331712 A1
(43) Pub. Date: Nov. 16, 2017

(54) PERFORMANCE TRACKING OF AN APPLICATION DURING A SINGLE USER SESSION

(71) Applicant: QUEST SOFTWARE INC., ALISO VIEJO, CA (US)

(72) Inventors: Stephen Curtis Fox, Frisco, TX (US); William G. Wixted, III, San Diego, CA (US); Zheng Wang, GuangDong (CN); Peisen Lin, GuangDong (CN); Yinghua Qin, GuangDong (CN)

(21) Appl. No.: 15/155,243

(22) Filed: May 16, 2016

(51) Int. Cl. H04L 12/26; H04L 29/06; H04L 29/08

(52) U.S. Cl. CPC H04L 43/08; H04L 67/02; H04L 67/42

(57) ABSTRACT

Systems and techniques to monitor performance of a single user session of an application installed in a client device are described. The application may transmit a request for data to a first server, and receive a response from the first server, the response including the requested data. The application may transmit, to a second server, (i) a transmit time at which the request is transmitted, and (ii) a receive time at which the response is received. The second server may facilitate displaying, on a computing device, the transmit time and the receive time. A developer may view such display to analyze the performance of the application during a single user session.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A developer may develop an application that may be deployed in multiple client devices. The developer may desire to monitor performance of the application being executed in the client devices. Based on such monitoring of the performance, the developer may identify potential performance issues and bottlenecks with the application, and improve the application.

### SUMMARY

This Summary provides a simplified form of concepts that are further described below in the Detailed Description. This Summary is not intended to identify key or essential features and should therefore not be used for determining or limiting the scope of the claimed subject matter.

Systems and techniques to monitor performance of a single user session of an application installed in a client device are described. The application may transmit a request for data to a first server, and receive a response from the first server, the response including the requested data. The request and the response, in combination, may be a hit required to display an application screen on the client device. The application may transmit, to a second server, (i) an indication of a transmit time at which the request is transmitted, and (ii) an indication of a receive time at which the response is received. That is, the application may transmit, to the second server, indications of a start time and a stop of the hit. The second server may facilitate displaying, on a computing device, the indications of the transmit time and the receive time. A developer may view such indications to analyze the performance of the application during a single user session.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram illustrating a computing system that includes a client device communicating with a plurality of servers over a network, where one of the servers is configured to monitor performance of an application installed in the client device, according to some embodiments.

FIG. 2A schematically illustrates the client device of FIG. 1 in more details, according to some embodiments.

Each of FIGS. 2B, 2C and 2D schematically illustrate a corresponding server of FIG. 1 in more details, according to some embodiments.

FIG. 3 illustrates an example application screen displayed on a display screen of a client device, according to some embodiments.

FIG. 4 illustrates a table that identifies example hits for displaying an application screen, according to some embodiments.

FIG. 5 illustrates another example application screen displayed on a display screen of a client device, according to some embodiments.

FIG. 6 illustrates another table that identifies example hits for displaying an application screen, according to some embodiments.

FIG. 7 illustrates another example application screen displayed on a display screen of a client device, according to some embodiments.

FIG. 8 illustrates another table that identifies example hits for displaying an application screen, according to some embodiments.

FIG. 9 illustrates another example application screen displayed on a display screen of a client device, according to some embodiments.

FIG. 10 illustrates another table that identifies example hits for displaying an application screen, according to some embodiments.

FIG. 11 illustrates an example user interface (UI) presented to a developer by an application engine, where the UI displays correlated hits in an application during a single user session, according to some embodiments.

FIG. 12 illustrates another example UI presented to a developer by an application engine, where the UI displays correlated hits in an application during a single user session, according to some embodiments.

FIG. 13 is a flowchart of a process that includes monitoring performance of a single user session of an application being executed on a client device, according to some embodiments.

FIG. 14 is a flowchart of a process that includes facilitating display of information indicating performance of a single user session of an application being executed on a client device, according to some embodiments.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

Systems and techniques are described herein to monitor performance of a single user session of an application installed in a client device. For example, in some implementations, the application installed in the client device may display, on a display screen of the client device, a sequence of application screens. Each application screen may display corresponding information to a user of the client device. The user may browse through various application screens by, for example, interacting with the application via one or more appropriate input devices of the client device (e.g., a touch screen, a stylus, a mouse, a keyboard, a trackball, and/or the like).

To display an application screen, the application may receive content from one or more servers over a network, and display the received content. For example, the application may transmit multiple requests for content to the servers, and receive corresponding multiple responses from the servers including the content. A request for content, as transmitted by the application to a server, and a response including the content may, in combination, be referred to herein as a “hit.” A “hit” may also refer to processing performed by the application to load an initial underlying layer of an application screen. Thus, to display an application screen, the application may need several hits to receive contents needed to display the application screen.

In an example, the application may track various performance metrics associated with the hits generated for an application screen. For example, the application may transmit a first request for first data to a first server and a second request for second data to a second server, where the first and second requests may be transmitted while a first application screen is being displayed by the application on the client device. The application may receive (i) a first response from the first server, the first response including the requested first data, and (ii) a second response from the second server, the second response including the requested second data. The first request and the first response, in combination, may be a first hit; and the second request and the second response, in combination, may be a second hit. The application may record and store an indication of a first transmit time at which the first request is transmitted, an indication of a second transmit time at which the second request is transmitted, an indication of a first receive time at which the first response is received, and an indication of a second receive time at which the second response is received. Thus, these indications may identify a start and stop time of the first and second hits. The application may also record and store the start and stop time of the various other hits needed to display the first application screen. The application may transmit, to a monitoring server, the start and stop time of each of the hits needed to display various application screens.

The application may also transmit to the monitoring server various other information associated with the flow of various application screens during the user session. For example, the application may also transmit to the monitoring server a start and stop time for displaying individual application screens, and a sequence in which the application screens are being displayed.

The monitoring server may display the information received form the application to a developer. The developer may analyze such information, identify potential performance issues of the application running in the client device, and improve the performance of the application.

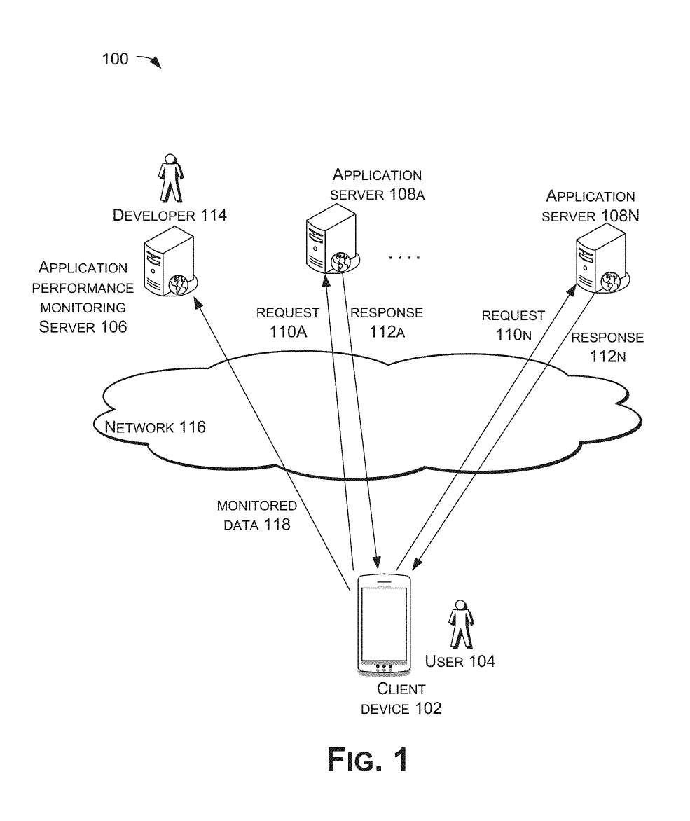

FIG. 1 is a block diagram illustrating a computing system 100 that includes a client device 102 communicating with an application performance monitoring server 106 (also referred to herein as “server 106”) and a plurality of application servers 108a, . . . , 108N (also referred to herein as “servers 108A, . . . , 108N”) over a network 116. In an example, the client device 102 may include a personal computer, an electronic book reader (e-book reader), a tablet computer, a mobile telephone (including smart phones), a personal digital assistant (PDA), a television, a set top box, a gaming console, or another electronic, portable or handheld device. In an example, the client device 102 may comprise an appropriate consumer electronic device that is configured to execute one or more application programs stored thereon. In an example, one or more users (e.g., a user 104) may interact with the client device 102 via, for example, an appropriate input device (not illustrated in FIG. 1), e.g., a touch screen, a key board, a stylus, a mouse, a trackball, and/or the like.

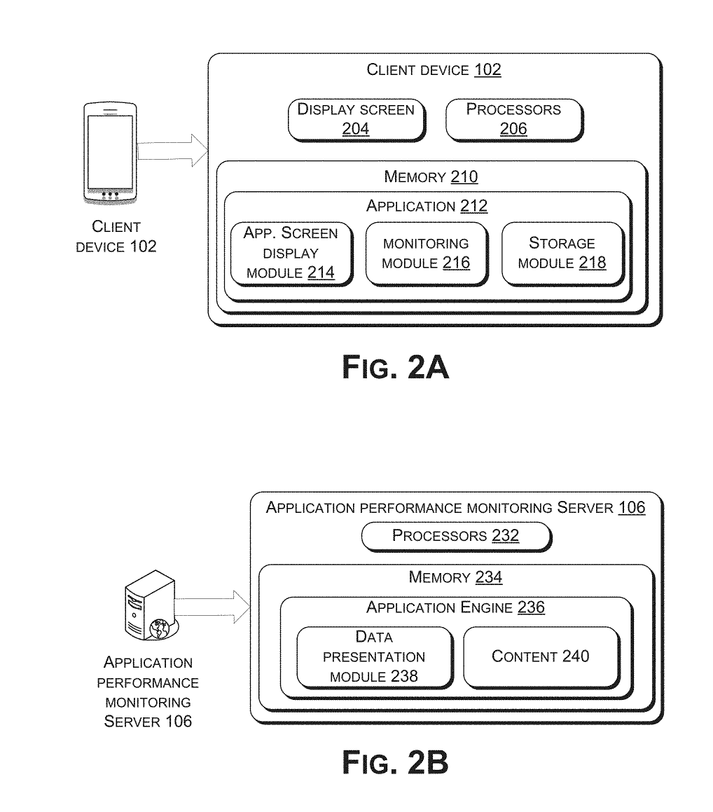

FIG. 2A schematically illustrates the client device 102 of FIG. 1 in more details. In an example, the client device 102 may include a display screen 204, one or more processors 206, and a memory 210 to store applications and data.

Memory 210 is an example of computer storage media (e.g., memory storage device) for storing instructions which are executed by the processors 206 to perform the various functions described above. For example, memory 210 may generally include both volatile memory and non-volatile memory (e.g., RAM, ROM, or the like) devices, hard disk drives, solid-state drives, removable media, including external and removable drives, memory cards, flash memory, floppy disks, optical disks (e.g., CD, DVD), a storage array, a network attached storage, a storage area network, or the like. The memory 210 may be referred to as computer storage media herein, and may be a media capable of storing computer-readable, processor-executable program instructions as computer program code that can be executed by the processors 206 as a particular machine configured for carrying out the operations and functions described in the implementations herein.

The processors 206 may comprise one or more hardware devices (e.g., integrated circuits) that may include a single processing unit or a number of processing units, all or some of which may include single or multiple computing units or multiple cores. The processors 206 can be implemented as one or more microprocessors, microcomputers, microcontrollers, digital signal processors, central processing units, state machines, logic circuitries, and/or any devices that manipulate signals based on operational instructions. Among other capabilities, the processors 206 can be configured to fetch and execute computer-readable instructions stored in the memory 210 or other computer-readable media.

The display screen 204, such as a monitor or other appropriate display may be included for displaying information and images to users, e.g., the user 104.

Although the client device 102 may have many other components, these components are not illustrated in FIG. 2A for purposes of illustrative clarity. For example, although not illustrated in FIG. 2A, the client device 102 may also include one or more communication interfaces for exchanging data via the network 116 (e.g., to communicate with the servers 106, 108). The communication interfaces may facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet and the like. Communication interfaces can also provide communication with external storage (not shown), such as in a storage array, network attached storage, storage area network, or the like. In another example, although not illustrated in FIG. 2A, the client device 102 may also include one or more input/output devices (e.g., in addition to the display screen 204) that may receive various inputs from a user and provide various outputs to the user, and may include a keyboard, a remote controller, a mouse, a printer, audio input/output devices, and so forth.

The client device 102 may have many application programs (henceforth referred to as “applications”) installed thereon, which may be executed by the processors 206 on the client device 102. These applications may be used for a variety of purposes. For example, the client device 102 may have a first application for logging in and viewing a social networking website, a second application for playing a game, a third application for viewing maps, and so on. As an example, FIG. 2A illustrates the memory 210 storing an application 212 that may be executed by the processors 206 on the client device 102, e.g., resulting in display of information on the display screen 204 of the client device 102. Although only a single application 212 is illustrated in FIG. 2A as being stored in the memory 210, multiple applications may be stored in the memory 210. The application 212 may include an application screen display module 214, a monitoring module 216 and a storage module 218, each of which will be discussed in more details herein later. The memory 210 may include instructions (e.g., the application 212) that, when executed by the processors 206 in the client device 102, may cause the processors 206 to perform one or more operations described herein.

Referring again to FIG. 1, the client device 102 may communicate with the servers 106, 108a, . . . , 108N over the network 116. The network 116 may be a wireless or a wired network, or a combination thereof The network 116 may be a collection of individual networks interconnected with each other and functioning as a single large network (e.g., the Internet or an intranet). Examples of such individual networks include, but are not limited to, telephone networks, cable networks, Local Area Networks (“LANs”), Wide Area Networks (“WANs”), and Metropolitan Area Networks (“MANs”). Further, the individual networks may be wireless networks, wired networks, or a combination thereof

As illustrated in FIG. 1, the servers 106, 108a, . . . , 108N communicate with the client device 102. The server 106, as discussed in more details herein later, may provide support for the application 212 being executed in the client device 102. For example, a developer 114 may upload the application 212, and/or updates to the application 212 on the server 106, and the client device 102 may receive the application 212 and/or updates to the application 212 from the server 106. In another example, the monitoring module 216 of the application 212 executing on the client device 102 may monitor the performance of the application 212, and periodically transmit monitored data 118 to the server 106. The monitored data 118 may provide an indication of the performance of the application 212 being executed on the client device 102.

The developer 114 may represent one or more persons, groups or organizations responsible for developing the application 212, periodically updating and improving the application 212, monitoring a performance of the application 212, and/or the like.

The developer 114 may access the monitored data 118 from the server 106 by any appropriate manner. For example, the developer 114 may access the server 106 over a network (not illustrated in FIG. 1), and view the monitored data 118 from the server 106 over the network. In another example, the server 106 may have a display screen connected thereon, and the developer may view the monitored data 118 on the display screen connected to the server 106. In yet another example, the server 106 may transmit the monitored data 118 to the developer 114 periodically, e.g., via email, Short Message Service (SMS), Multimedia Messaging Service (MMS), and/or the like. In an example, as the server 106 monitors the performance of the application 212 running on the client device 102, the server 106 is also referred to herein as the application performance monitoring server.

In an example, the client device 102 may receive content from the servers 108a, . . . , 108N. For example, as illustrated in FIG. 1, the client device 102 may transmit a request 110a for content to the server 108a, and receive a response 112a from the server 108a that includes the requested content. In another example, the client device 102 may transmit a request 110N for content to the server 108N, and receive a response 112N from the server 108N that includes the requested content. As the application 212 receives content from the servers 108a, . . . , 108N, the servers 108a, . . . , 108N are also referred to herein as application servers. Although not illustrated in FIG. 1, the client device 102 may also receive content from the server 106.

Content, as used herein, refers to any appropriate type of data that may be consumed by the application 212 being executed in the client device 102. For example, content may comprise any appropriate type of data (e.g., images, information, emails, maps, etc.) that are being displayed by the application 212 on the display screen 204, or otherwise used by the application 212.

FIG. 2B illustrates the server 106 in more details. The server 106 comprises processors 232 and memory 234 that stores an application engine 236. The memory 234 may include instructions (e.g., associated with the application engine 236) that, when executed by the processors 232 in the server 106, may cause the processors 232 to perform one or more operations described herein.

The application engine 236 may communicate with the application 212 stored in the client device 102. In an example, the application engine 236 may support the application 212 being executed in the client device 102, provide updates to the application 212, and/or communicate otherwise with the application 212 to enable to application 212 to run on the client device 102. In another example, the application engine 236 may periodically receive the monitored data 118 from the application 212 running in the client device 102.

In an example, the application engine 236 may include a data presentation module 238. The data presentation module 238 may receive the monitored data 118 from the application 212, and present the data in an appropriate format to the developer 114. The application engine 236 may also include content 240 that may be transmitted to the application 212, while the application 212 is being executed in the client device 102.

FIG. 2C illustrates the server 108a in more details, and FIG. 2D illustrates the server 108N in more details. The servers 108a and 108N comprise processors 262a and 262N, respectively, and further comprise memory 264a and 264N, respectively. The memory 264a and 264N respectively store content 266a and 266N. The content 266a and 266N (or at least part of the content 266a, 266N), for example, may be transmitted to the client device 102 along with the response 112a and the response 112N, respectively, as discussed with respect to FIG. 1.

Referring again to FIGS. 1 and 2A, while the application 212 is being executed on the client device 102, the application 212 may display information on the display screen 204 of the client device 102. In an example, the application 212 may display a series of application screens on the display screen 204. Each application screen may include content or information (e.g., data, pictures, video, etc.) that are to be displayed to the user 104. Merely as an example, if the application 212 is for viewing parking garages in a specific location, a first application screen may display a portion of a map of a location selected by the user 104. In a second application screen, the application 212 may display various parking garages available in the portion of the map displayed in the first application screen. In a third application screen, the application 212 may display information about a specific parking garage that was displayed on the second application screen.

The user 104 may interact with the application 212, e.g., via an appropriate input interface of the client device 102. For example, the user 104 may interact with the application 212 via a touchscreen of the client device 102, a stylus, a mouse, a trackball, and/or the like. While a first application screen is displayed, the user 104 may interact with the application 112 (e.g., may tap on or select a navigation bar, a tab bar, a UI control, and/or the like) such that the application switches the display to a second application screen. In another example, such a change in the application screen may be based on any another factor, e.g., information displayed on the first application screen being automatically updated, updated after lapse of certain time period, or the like.

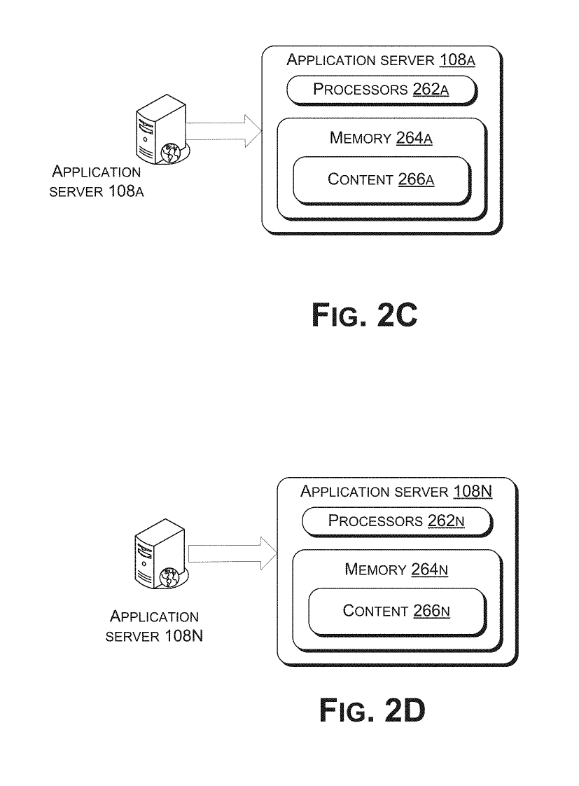

FIG. 3 illustrates an example application screen 300 displayed on the display screen 204 of the client device 102 by the application 212. In FIG. 3 (and various other subsequent figures herein later), it is assumed that the application 212, among other things, may provide mapping functionality and may facilitate finding parking garages to the user 104. However, the principles of this disclosure is not limited to such specific functionalities of the application 212, and the principles of this disclosure may be applied to various other types of applications as well.

Referring to FIG. 3, the application screen display module 214 of the application 212 may facilitate display of the application screen 300 on the display screen 204 of the client device 102. The application screen 300 may display, for example, a map of a location selected by the user 104, including various streets in the map. In an example, the application screen 300 may also display various public parking garages in the map. For example, the application screen 300 may display parking garages A, . . . , D, and may also display a dollar value to park a car for an entire day in individual ones of the parking lots A, . . . , D. In an example, the application screen 300 is loaded based on the user 104 launching the application 212, the user 104 selecting a specific location in a map displayed on a prior application screen, or the like. It is to be noted that the application screen 300 is merely an example to explain the principles of the disclosure, and specifics of the application screen 300 does not limit the teachings of this disclosure.

To display an application screen, e.g., the application screen 300, the application 212 may need various content that are to be displayed on the application screen. For example, to display the application screen 300, the application 212 may need data on the map to be displayed, data on locations of various parking garages, data on the rate of parking in the parking garages, and/or the like. For individual ones of the content required to display an application screen, the application may send a request (e.g., the request 110a of FIG. 1) to a server (e.g., server 108a) that stores the appropriate content, and may receive a response (e.g., the response 112a of FIG. 1) including the requested content. To display the application screen 300a, the application 212 may send several such requests to one or more servers and receive several such responses from the servers. Individual ones of the requests may include a corresponding network address, e.g., an Internet Protocol (IP) address, from which the corresponding content is to be fetched. The requests and the responses may be transmitted and received using, for example, Hypertext Transfer Protocol (HTTP), or another appropriate protocol that may be used to transmit and receive such requests and responses over a network.

A request for content, as transmitted by the application 212 to a server (e.g., server 108a) and a response including the content may, in combination, be referred to herein as a “hit.” A “hit” may also refer to processing performed by the application 212 to load an initial underlying layer of an application screen. Thus, to display the application screen 300, the application 212 may need several such hits to receive contents for displaying the application screen 300.

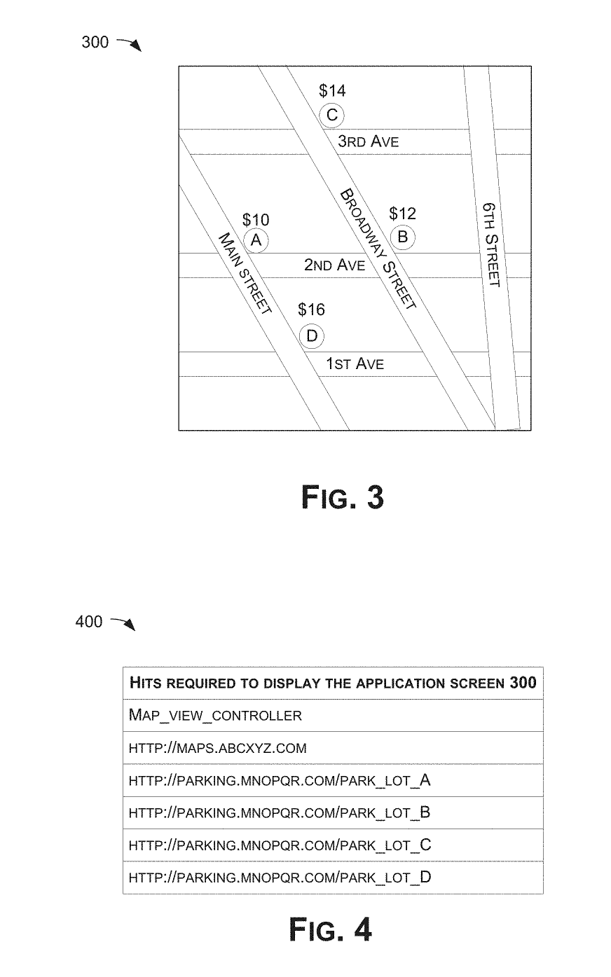

FIG. 4 illustrates a table 400 that identifies example hits for displaying the application screen 300. In an example, the application screen 300 may be named as “map view” by the application 212, which may be a screen name or a class name for the application screen 300. This name may not be visible to the user 104, but used by the application 212 for internal purposes (e.g., to communicate with the application engine 236).

The first hit in the table 400 may be “map_view_controller.” This hit may be associated with, for example, the application 212 processing a request to display the application screen 300, receive preliminary information from the application engine 212 to display the application screen 300, display or process an underlying layer of the application screen 300, and/or the like.

The second hit in the table 400 may associated with transmitting a request for data associated with a map to a server (e.g., server 108a) and receiving the requested content. For example, second hit in the table 400 identifies an example IP address (e.g., http://maps.abcxyz.com) to which the request may be transmitted. The third, fourth, fifth and sixth hits in the table 400 may be associated with transmitting multiple requests for data associated with various parking garages within the portion of the map displayed in the application screen 300. For example, the third hit may be associated with transmitting a request to an IP address http://parking.mnopqr.com/park_lot_A, for receiving data on the parking garage A, where the data includes a location of the parking garage A and a daily rate to park in the parking garage A. The hits illustrated in table 400 are merely examples, and does not limit the teachings of this disclosure.

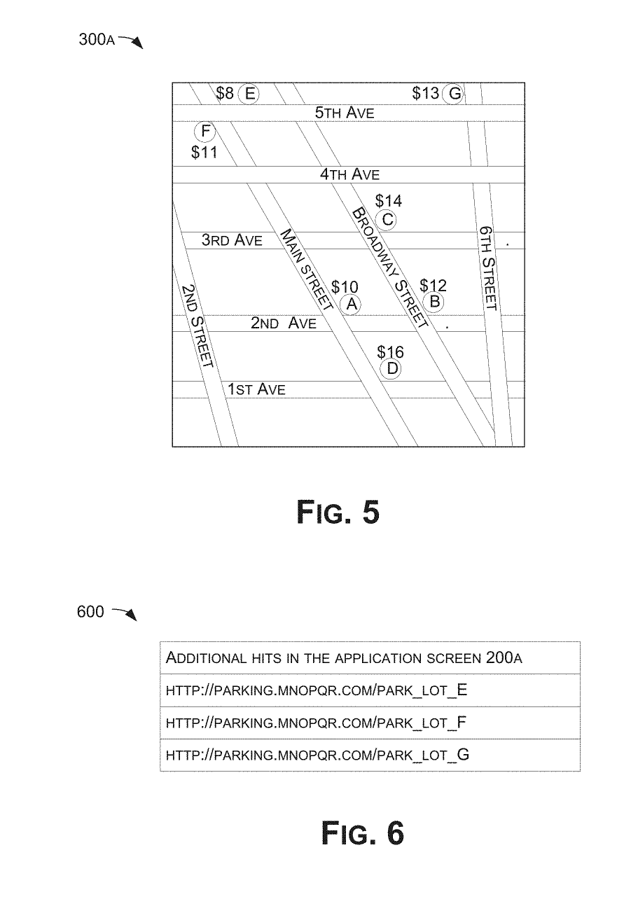

While the user 104 is viewing the application screen 300, the user 104 may zoom in, or zoom out of the map illustrated in the application screen 300. FIG. 5 illustrates an application screen 300a that is displayed in response to the user 104 zooming out in the application screen 300. Due to the zooming out of the application screen 300, the application screen 300a may cover more area in the map compared to the application screen 300. Accordingly, more parking garages (e.g., parking garages E, F and G) may be visible in the application screen 300a (e.g., compared to the application screen 300). FIG. 6 illustrates a table 600 that identifies example additional hits (e.g., in addition to the hits displayed in the table 400) for displaying the application screen 300a. For example, when the user 104 zooms out in the application screen 300, the application 212 generates the additional hits of table 600 to receive information associated with additional parking garages E, F and G from corresponding the IP addresses.

In an example, the application 212 may be configured to consider the application screens 300 and 300a to be a part of a same application screen (e.g., the application screen 300a may be considered as an extension of the application screen 300). In another example, the application 212 may be configured such that the application screen 300a may be considered to be a different application screen compared to the application screen 300. Such configuration may be performed, for example, by the developer 114, via the server 106.

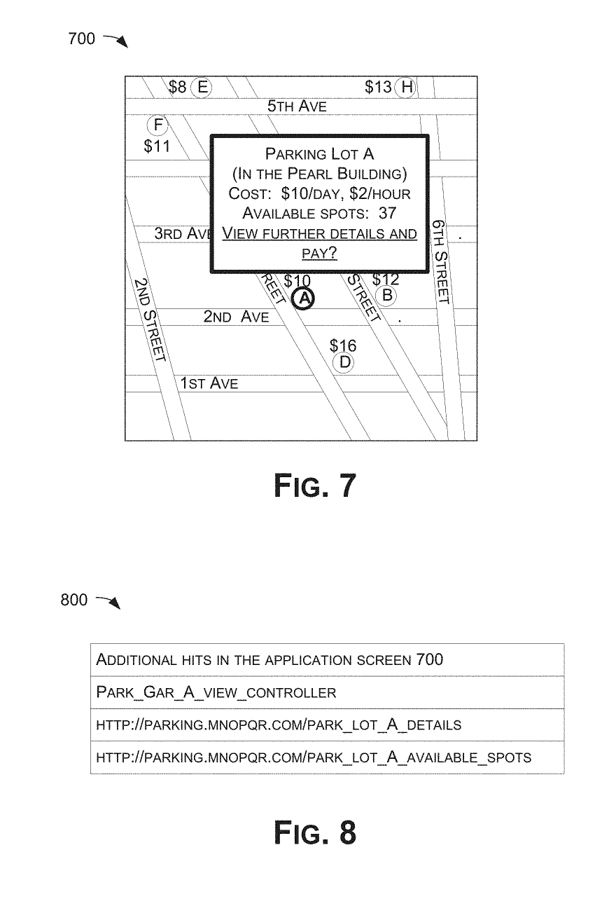

In an example, while the user 104 views the application screen 300a (or the application screen 300), the user 104 may also view details of a parking garage displayed on the map, e.g., by selecting (e.g., by clicking using a mouse, tapping or otherwise selecting) the parking garage. FIG. 7 illustrates an application screen 700 in which details of a parking garage A is displayed, based on the user 104 selecting the parking garage A to view corresponding details. The details of the parking garage A includes, for example, a location of the parking garage A, cost of parking in the parking garage A, number of available spots in the parking garage A for parking, and/or the like.

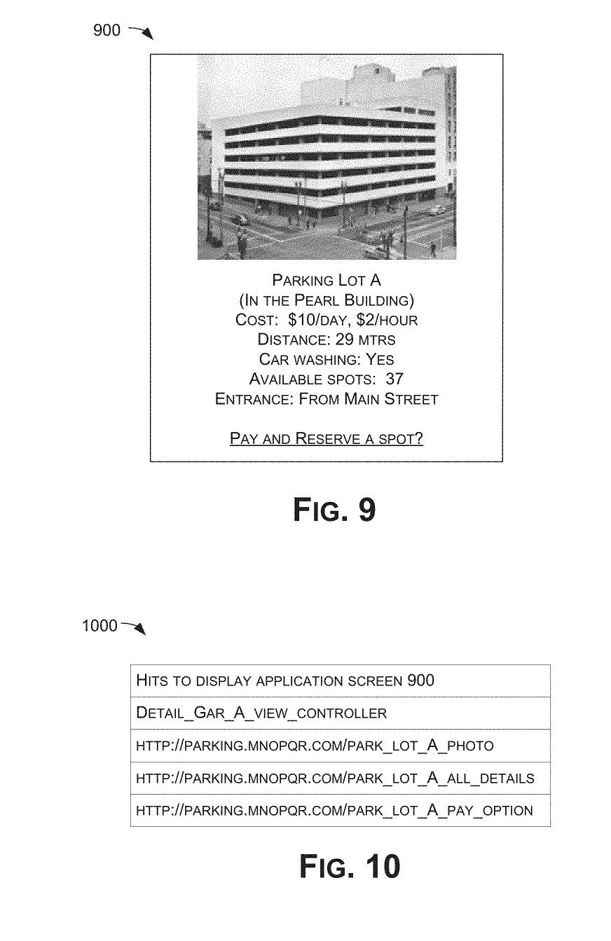

FIG. 8 illustrates a table 800 that identifies example hits for displaying the application screen 700. In an example, the application screen 700 may be named as “park_gar_A_view” by the application 212, which may be a screen name or a class name for the application screen 700. This name may not be visible to the user 104, but used by the application 212 for internal purposes (e.g., to communicate with the application engine 236). In an example, a first hit in the table 800 may be “park_gar_A_view_controller.” This hit may be associated with, for example, the application 212 processing a request to display the application screen 700, receive preliminary information from the application engine 212 to display the application screen 700, display or process an underlying layer of the application screen 700, and/or the like. A second hit of the table 800 may be associated with a request transmitted by the application 212 to an example IP address http://parking.mnopqr.com/park_lot_A_details, and in response receiving the details of the parking garage A. A third hit of the table 800 may be associated with a request transmitted by the application 212 to an example IP address http://parking.mnopqr.com/park_lot_A_available_spots, and in response receiving an indication of a number of stops available for parking in the parking garage A.

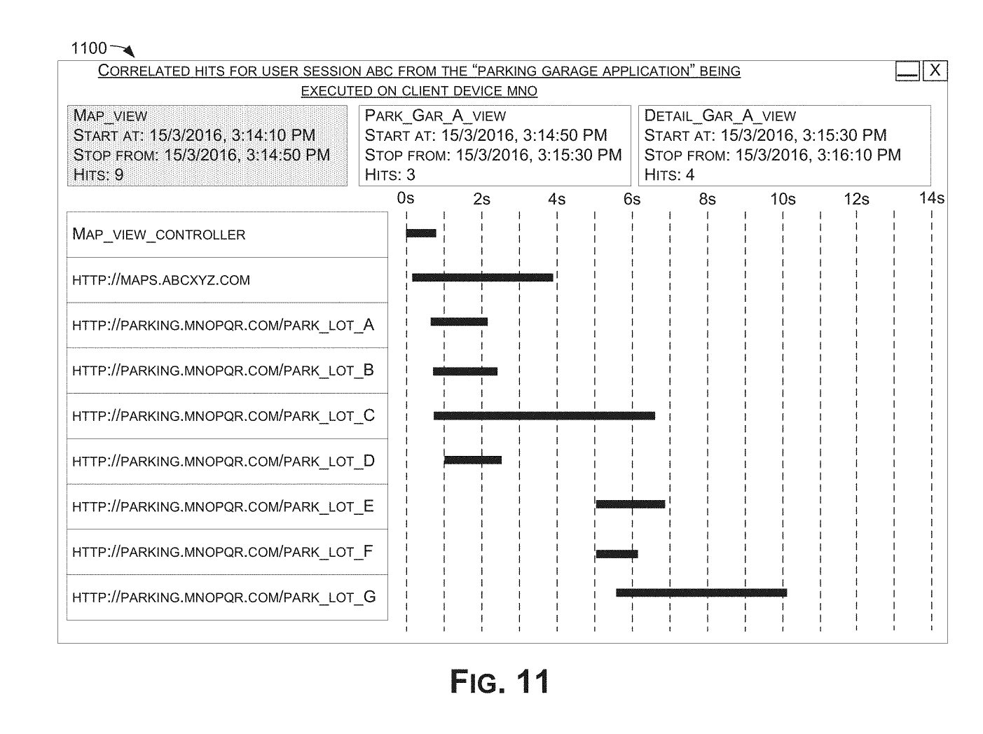

In an example, in the application screen 700, an option may be provided to illustrate further details of the parking garage A and pay for a spot in the parking garage A. In response to the user 104 selecting such an option, an application screen 900 of FIG. 9 may be displayed. The application screen 900 of FIG. 9 illustrates further details of the parking lot A, and provides an option to pay in advance and reserve a spot for parking in the parking garage A. FIG. 10 illustrates a table 1000 displaying hits for displaying the application screen 900, which includes hits associated with receiving further details (e.g., photo of the parking garage A, payment option to park, etc.) about the parking garage A.

It is to be noted that the application screens 300, 300a, 700 and 900 are merely examples used to discuss the principles of this disclosure, and does not limit the teachings of this disclosure to the specifics illustrated in these application screens. Also, the user 104 may interact further with the application screen 900 to generate further application screens, although such application screens are not illustrated in the figures for purposes of brevity and to not obfuscate the principles of this disclosure.

In an example, the monitoring module 216 of the application 212 may monitor the hits associated with displaying the application screens 300, 700 and 900. For example, the monitoring module 216 may store (e.g., in the storage module 218) information associated with a start time of a hit, a duration of the hit, an end time of the hit, number of hits associated with individual application screens, and/or the like. A start time of a hit may be the time at which a corresponding request is transmitted to a server, requesting content; and an end time of the hit may be the time at which a corresponding response is received form the server, where the response includes the requested content. The monitoring module 216 may transmit such information in the form of monitored data 118 to the server 106 (e.g., to the application engine 236 executing in the server 106).

In an example, the monitoring module 216 may transmit the monitored data 118 to the server 106 periodically, e.g., every 60 seconds, every 120 seconds, once every hour, once every day, or the like. In another example, the monitoring module 216 may transmit the monitored data 118 to the server 106 when bandwidth is available to send such information, when the application 212 is running but is relatively idle (e.g., low workload), when the client device 102 has relatively low workload, and/or the like.

The developer 114 may access the monitored data 118 from the application engine 236 by any appropriate manner. For example, the developer 114 may access the server 106 over a network, e.g., the Internet, (not illustrated in FIG. 1), and view the monitored data 118 from the server 106 over the network. In another example, the server 106 may have a display screen connected thereon (not illustrated in FIG. 1), and the developer 114 may view the monitored data 118 on the display screen connected to the server 106. In yet another example, the server 106 may periodically transmit the monitored data 118 to the developer 114 periodically, e.g., via email, Short Message Service (SMS), Multimedia Messaging Service (MMS), and/or the like.

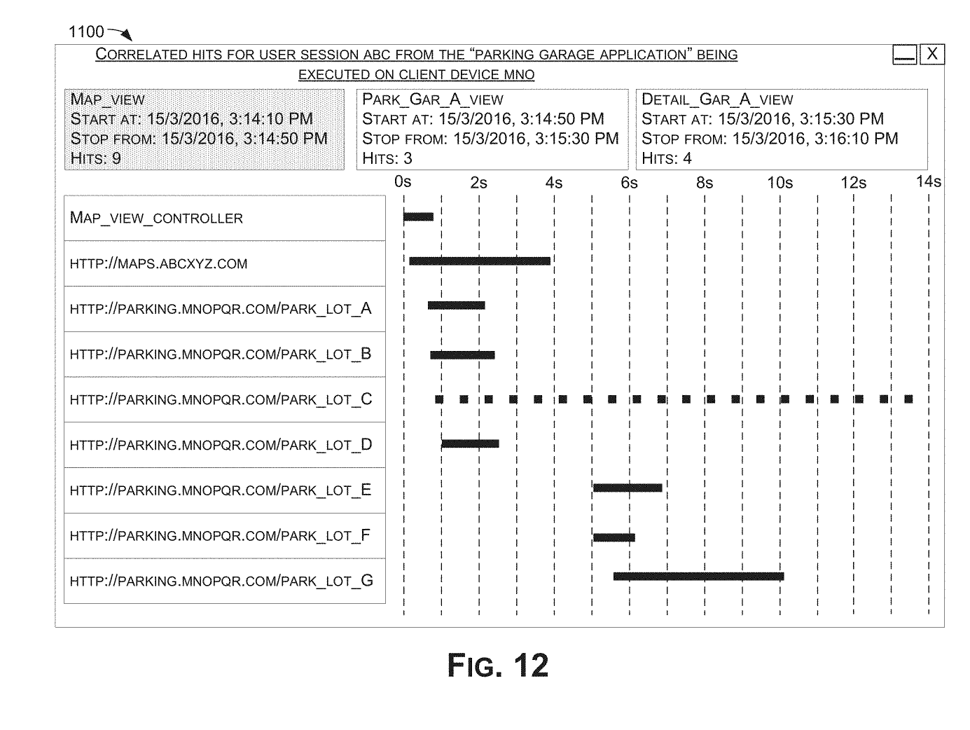

FIG. 11 illustrates an example user interface (UI) 1100 presented to the developer 114 by the application engine 236 (e.g., by the data presentation module 238), where the UI 1100 displays correlated hits in the application 212 during a single user session. In an example, the UI 1100 may be presented in a display screen of a computing device (not illustrated in FIG. 1) that can be accessed and viewed by the developer 114. The UI 1100 may be generated by the data presentation module 238, e.g., based on the monitored data 118 received by the application engine 236 from the application 212 running on the client device 102. The UI 1100 may include information (e.g., correlated hits) for a single user session (e.g., identified as “user session ABC” in FIG. 11) from the application 212 (e.g., identified as the “parking garage application” in FIG. 11) being executed on the client device 102 (e.g., identified as “client device MNO” in FIG. 11).

As discussed with respect to FIGS. 3-10, three example application screens 300, 700 and 900 are displayed by the application 212. In FIG. 11, the application screens 300, 700 and 900 are respectively identified by their screen names or class names “map_view,” “park_gar_A_view,” and “detail_gar_A_view.” The UI 1100 illustrates three UI controls to display the correlated hits for the three respective applications screens. As the correlated hits for the application screen “map_view” (i.e., application screen 300) is being currently displayed, the corresponding UI control is highlighted using shadings. As illustrated in FIG. 11, a start time of individual application screens (i.e., when an application screen is launched), a stop time of individual application screens (i.e., when the user 104 switches to a different application screen), and a number of hits for individual application screens are displayed in the UI 1100.

The UI 1100 also displays, for the application screen “map_view,” the hits associated with the application screen, a start time of each hit, a duration of each hit, and a stop time of each hit. For example, the hit associated with the IP address http://maps.abcxyz.com starts sometime after 0 second, and ends sometime before 4 second. Thus, this hit takes about 3.5 seconds to complete. It is to be noted that the “0 second” in FIG. 11 corresponds to the start time of the application screen “map_view,” which is at 3:14:10 PM of Mar. 15, 2016. In another example, the hit associated with the IP address http://parking.mnopqr.com/park_lot_E starts at about 5 second, and ends at about 7 second. Thus, this hit takes about 2 seconds to complete.

It is to be noted that the seventh, eighth and the ninth hits in FIG. 11 (i.e., the hits associated with the parking garages E, F and G) start at about 5 second or later. As discussed with respect to FIGS. 5 and 6, these hits are based on the user 104 zooming out application screen 300. As an example, the user 104 may zoom out the application screen 300 at about 5 second from launching the application screen 300, as a result of which these hits also start at about 5 second from the launching of the application screen 300.

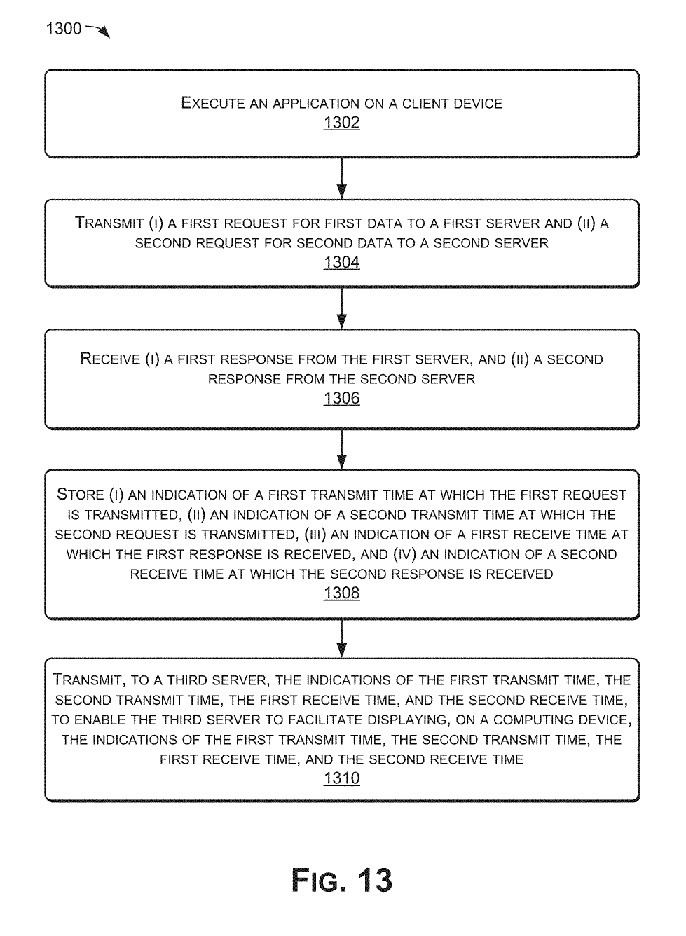

Various other information may also be presented to the developer 114 via an UI. For example, FIG. 12 illustrates another example UI 1100a presented to the developer 114 by the application engine 236 (e.g., by the data presentation module 238), where the UI 1100a displays correlated hits in the application 212 during a single user session. The UI 1100a of FIG. 12 is at least in part similar to the UI 1100 of FIG. 11. However, in the UI 1100a, one of the hits results in an error or failure (e.g., if a request associated with the hit to a server results in an error, or if no corresponding response is received from the server), and such information may also be displayed in the UI 1100a. For example, a hit to the IP address http://parking.mnopqr.com/park_lot_C results in an error, failure or no response. Accordingly, this hit may be displayed using dashed line in the UI 1100a. The developer 114 may view the dashed line and readily know that this hit resulted in an error or failure.

Various other information may also be included in an UI presented to the developer 114. For example, the UIs 1100 or 1100a (or another appropriate UI) may track a flow of application screens, i.e., illustrate or otherwise identify a sequence in which the user 114 accesses various application screens. In yet another example, if a user 114 quits the application 212 while browsing a specific application screen, such information may also be noted in the UI 1100. Thus, the UIs 1100, 1100a (or another UI) may include various information about flow of the application screens (e.g., a sequence with which the application screens are being displayed) and the hits associated with various application screens for a single user session of the application 212.

Referring again to FIG. 11, in the UI 1100, each hit associated with an application screen has a corresponding start time of the hit, a stop time of the hit, and a time duration to execute the hit. Thus, individual hits are correlated to a corresponding start and stop time, and a corresponding time duration, i.e. the UI 1100 presents information about correlated hits for each application screen from a single user session.

Furthermore, the UI 1100 indicates a start and a stop time of each application screen in a single user session from a single client device, and also tracks the flow of the application screens. For example, the UI 1100 indicates a sequence in which various application screens are displayed, e.g., by indicating a start and a stop time of each application screen.

The developer 114 may gain useful information by analyzing the UI 1100 or 1100a. For example, the UI 1100 or 1100a may provide the developer 114 information about a time required to build and present each application screen. The UI 1100 or 1100a may also provide the developer 114 information about a time duration a user dwells on an application screen. The UI 1100 or 1100a may also provide the developer 114 information about the hits, along with detailed performance metrics and possible error information about individual hits.

Thus, a developer may analyze a single user's behavior and performance issue by user-session at a fine-grained level. For example, assume an application for online shopping that has at least four application screens: a first application screen to search products, a second application screen to view product details, a third application screen to checkout a product, and a fourth application screen for payment. If a user quits the application prior to completing the payment, the UI 1100 (or a UI that is tailored for use with the application for online shopping) may indicate the application screen at which the user 104 quits the application. Thus, the developer 114 may know the point at which the user quits the application, and a customer service representative may contact the user 104 for further feedback gathering so that the business flow and user experience can be improved.

Also, illustrating the correlated hits for an application screen may enable the developer 114 to analyze the user-session at a fine-grained level. For example, the application screen “map view” has nine hits. By analyzing the UI 1100a, the developer 114 may determine that at least one hit (e.g., the hit to the IP addresses http://parking.mnopqr.com/park_lot_G) took relatively long time to complete (e.g., took more than a threshold time period to complete), one hit resulted in an error (e.g., the hit to the IP addresses http://parking.mnopqr.com/park_lot_C). The developer 11 may investigate these two hits to find out the root cause of the performance issues (e.g., cause of the relatively long time to execute these the hit, and failure of the hit).

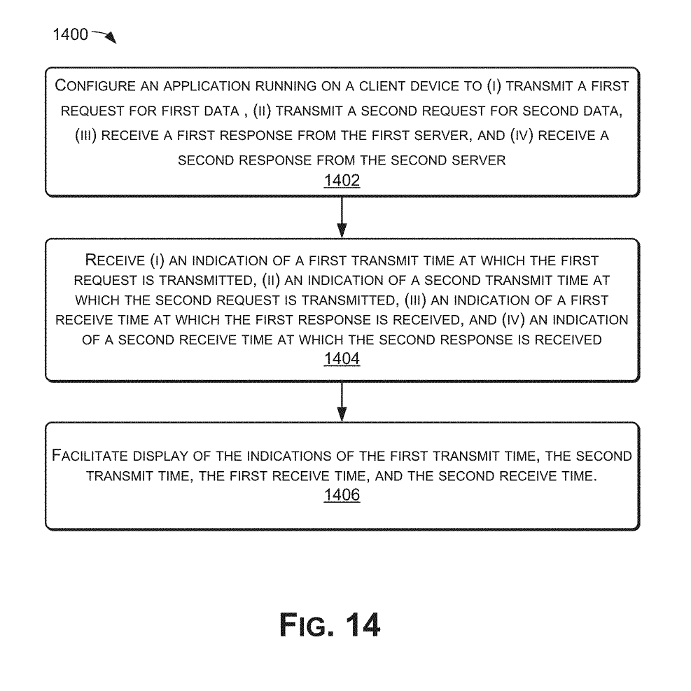

FIGS. 12 and 13 illustrate application screen names and hits that are specifically associated with the application 212. However, the example application screen names and the example hits illustrated in FIGS. 12 and 13 do not in any way limit the scope of this disclosure, and the application screen names and hits of FIGS. 12 and 13 are merely examples. The principles of this disclosure may be applied to monitor performance of any other application, and based on the application, the application screen names and the hits of FIGS. 12 and 13 can be modified accordingly.

FIG. 13 is a flowchart of a process 1300 that includes monitoring performance of a single user session of an application being executed on a client device. The process 1300 may be performed by the client device 102 of FIG. 1.

At 1302, an application (e.g., the application 212) may be executed in a client device (e.g., client device 102). At 1304, the application running on the client device may transmit (i) a first request for first data to a first server (e.g., a request transmitted to the server 108a, the request being associated with a first hit listed in the table 400 of FIG. 4) and (ii) a second request for second data to a second server (e.g., a request transmitted to the server 108N, the request being associated with a second hit listed in the table 400 of FIG. 4). In an example, the first and second requests may be transmitted while a first application screen (e.g., the application screen 300 of FIG. 3) is being displayed by the application on the client device. At 1306, the application may receive (i) a first response from the first server, the first response including the requested first data, and (ii) a second response from the second server, the second response including the requested second data. At 1308, the application may store (e.g., in the storage module 218 of FIG. 2) (i) an indication of a first transmit time at which the first request is transmitted, (ii) an indication of a second transmit time at which the second request is transmitted, (iii) an indication of a first receive time at which the first response is received, and (iv) an indication of a second receive time at which the second response is received. At 1310, the application may transmit, to a third server (e.g., the server 106), the indications of the first transmit time, the second transmit time, the first receive time, and the second receive time. The third server may facilitate displaying, on a computing device, the indications of the first transmit time, the second transmit time, the first receive time, and the second receive time, e.g., as illustrated in FIGS. 11 and 12. In an example, a developer (e.g., the developer 114) may view such indications to analyze the performance of a single user session of the application being executed on the client device.

FIG. 14 is a flowchart of a process 1400 that includes facilitating display of information indicating performance of a single user session of an application being executed on a client device. The process 1400 may be performed by the server 106 of FIG. 1.

At 1402, a server (e.g., the server 106 of FIG. 1) may configure an application (e.g., application 212) running on a client device (e.g., client device 102) to (i) transmit a first request for first data, (ii) transmit a second request for second data, (iii) receive a first response from the first server, and (iv) receive a second response from the second server. In an example, the first and second responses may respectively include the requested first and second data. In an example, the first request may be transmitted to, and the first response may be received from a first server. In an example, the second request may be transmitted to, and the second response may be received from a second server. The first and second requests may be transmitted while a first application screen (e.g., application screen 300 of FIG. 3) is being displayed by the application on the client device.

At 1404, the server may receive, from the application, (i) an indication of a first transmit time at which the first request is transmitted, (ii) an indication of a second transmit time at which the second request is transmitted, (iii) an indication of a first receive time at which the first response is received, and (iv) an indication of a second receive time at which the second response is received. At 1406, the server may facilitate display of the indications of the first transmit time, the second transmit time, the first receive time, and the second receive time, e.g., as illustrated in FIGS. 11 and 12. In an example, a developer (e.g., the developer 114) may view such indications to analyze the performance of a single user session of the application being executed on the client device.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, and can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various embodiments of the method and apparatus of the present disclosure have been illustrated herein in the Drawings and described in the Detailed Description, it will be understood that the disclosure is not limited to the embodiments disclosed, and is capable of numerous rearrangements, modifications and substitutions without departing from the scope of the present disclosure.

What is claimed is:

1. A computer-implemented method, comprising:
displaying, by an application executing on a client device, a first application screen;
transmitting, by the application, (i) a first request for first data to a first server and (ii) a second request for second data to a second server, wherein the first and second requests are transmitted while the first application screen is being displayed by the application on the client device;
receiving, by the application, (i) a first response from the first server, the first response including the requested first data, and (ii) a second response from the second server, the second response including the requested second data;
storing (i) a first transmit time at which the first request is transmitted, (ii) a second transmit time at which the second request is transmitted, (iii) a first receive time at which the first response is received, and (iv) a second receive time at which the second response is received; and
transmitting, by the application to a third server, the first transmit time, the second transmit time, the first receive time, and the second receive time, to enable the third server to facilitate displaying, on a computing device, the first transmit time, the second transmit time, the first receive time, and the second receive time, to enable analyzing a performance of the application.

2. The computer-implemented method of claim 1, further comprising:
determining a first time duration comprising a first difference between the first transmit time and the first receive time;
determining a second time duration comprising a second difference between the second transmit time and the second receive time; and
facilitate displaying, on the computing device, the first time duration and the second time duration.

3. The computer-implemented method of claim 1, further comprising:
storing (i) a first start time at which the application starts displaying the first application screen, and (ii) a first stop time at which the application stops displaying the first application screen; and transmitting, by the application to the third server, the first start time and the first stop time, to enable the third server to facilitate displaying, on the computing device, the first start time and the first stop time.

4. The computer-implemented method of claim 3, further comprising:
subsequent to displaying the first application screen, displaying, by the application, a second application screen;
storing (i) a second start time at which the application starts displaying the second application screen, (ii) a second stop time at which the application stops displaying the second application screen; and
transmitting, by the application to the third server, the second start time and the second stop time, to enable the third server to facilitate displaying, on the computing device, the second start time and the second stop time.

5. The computer-implemented method of claim 1, further comprising:
subsequent to displaying the first application screen, displaying, by the application, a second application screen and a third application screen;
storing an identification of a sequence with which the first, second and third application screens are displayed; and
transmitting, by the application to the third server, the identification of the sequence with which the first, second and third application screens are displayed on the client device, to enable the third server to facilitate displaying, on the computing device, the identification of the sequence with which the first, second and third application screens are displayed.

6. The computer-implemented method of claim 1, further comprising:
transmitting, by the application running on the client device, a third request for third data;
failing to receive, by the application, a response to the third request;
storing an indication of the failure to receive the response to the third request; and
transmitting, by the application to the third server, the indication of the failure to receive the response to the third request, to enable the third server to facilitate displaying, on the computing device, the indication of the failure to receive the response to the third request.

7. The computer-implemented method of claim 1, wherein the first server and the third server are the same server.

8. The computer-implemented method of claim 1, wherein the first request, the second request, the first response and the second response are communicated using the Hypertext Transfer Protocol (HTTP).

9. One or more non-transitory computer-readable media storing instructions that are executable by one or more processors to perform operations comprising:
configuring an application running on a client device to (i) transmit a first request for first data to a first server, (ii) transmit a second request for second data to a second server, (iii) receive a first response from the first server, the first response including the requested first data, and (iv) receive a second response from the second server, the second response including the requested second data, wherein the first and second requests are transmitted while a first application screen is being displayed by the application on the client device;
receiving, from the application, (i) a first transmit time at which the first request is transmitted, (ii) a second transmit time at which the second request is transmitted, (iii) a first receive time at which the first response is received, and (iv) a second receive time at which the second response is received; and
facilitating display of the first transmit time, the second transmit time, the first receive time, and the second receive time.

10. The one or more non-transitory computer-readable media of claim 9, wherein:
a first time duration comprises a first difference between the first transmit time and the first receive time;
a second time duration comprises a second difference between the second transmit time and the second receive time; and
the instructions are executable by the one or more processors to further perform operations comprising facilitating display of the first time duration and the second time duration.

11. The one or more non-transitory computer-readable media of claim 9, wherein the instructions are executable by the one or more processors to further perform operations comprising:
receiving, from the application, (i) a first start time at which the application starts displaying the first application screen, and (ii) a first stop time at which the application stops displaying the first application screen; and
facilitating display of the first start time and the first stop time.

12. The one or more non-transitory computer-readable media of claim 11, wherein the instructions are executable by the one or more processors to further perform operations comprising:
receiving, from the application, (i) a second start time at which the application starts displaying a second application screen, (ii) a second stop time at which the application stops displaying the second application screen, wherein the second application screen is displayed by the application subsequent to displaying the first application screen; and
facilitating display of the second start time and the second stop time.

13. The one or more non-transitory computer-readable media of claim 9, wherein the instructions are executable by the one or more processors to further perform operations comprising:
receiving an identification of a sequence with which the first application screen, a second application screen and a third application screen are displayed by the application on the client device; and
facilitating display of the identification of the sequence with which the first application screen, the second application screen and the third application screen are displayed by the application on the client device.

14. The one or more non-transitory computer-readable media of claim 9, wherein the instructions are executable by the one or more processors to further perform operations comprising:
configuring the application to transmit a third request for third data, wherein the application fails to receive a response to the third request;
receiving an indication of the failure to receive the response to the third request; and
facilitating display of the indication of the failure to receive the response to the third request.

15. The one or more non-transitory computer-readable media of claim 9, wherein the first server and the second server are the same server.

16. The one or more non-transitory computer-readable media of claim 9, wherein the first request, the second request, the first response and the second response are communicated using the Hypertext Transfer Protocol (HTTP).

17. A client device, comprising:
a display screen;
one or more processors; and
one or more non-transitory computer-readable media storing instructions that are executable by the one or more processors to:
display first information on the display screen;
to facilitate displaying the first information on the display screen, transmit a first request for first data;
receive a first response that includes the requested first data, the first information including the first data; and
transmit, to a computing device, (i) a first transmit time at which the first request is transmitted, and (ii) a first receive time at which the first response is received.

18. The client device of claim 17, wherein the instructions are further executable by the one or more processors to:
to further facilitate displaying the first information on the display screen, transmit a second request for second data;
receive a second response that includes the requested second data, the first information including the second data; and
transmit, to the computing device, (i) a second transmit time at which the second request is transmitted, and (ii) a second receive time at which the second response is received.

19. The client device of claim 17, wherein the instructions are further executable by the one or more processors to:
transmit, to the computing device, (i) a start time at which the client device starts displaying the first information, and (ii) a stop time at which the client device stops displaying the first information.

20. The client device of claim 17, wherein the instructions are further executable by the one or more processors to:
display second information and third information on the display screen; and
transmit an identification of a sequence with which the first, second and third information are displayed on the display screen.
